(19) United States
(12) Patent Application Publication
(10) Pub. No.: US 2014/0207267 A1
(43) Pub. Date: Jul. 24, 2014

(54) METRIC BASED ON ESTIMATE VALUE

(71) Applicant: HEWLETT-PACKARD DEVELOPMENT COMPANY, L.P., Houston, TX (US)

(72) Inventors: Kemal GULER, San Jose, CA (US); Jianqiang WANG, Palo Alto, CA (US)

(73) Assignee: HEWLETT-PACKARD DEVELOPMENT COMPANY, L.P., Houston, TX (US)

(21) Appl. No.: 13/748,198

(22) Filed: Jan. 23, 2013

(51) Int. Cl. G06F 17/00

(52) U.S. Cl. CPC G06F 17/60
USPC 700/97

(57) ABSTRACT

A method includes obtaining an estimate value generated by an estimation process and obtaining an actual value corresponding to the estimate value. The method further includes computing a metric based on a ratio of a loss function and a weighted sum of the estimate value and the actual value. The loss function includes a penalty parameter to control a relative penalty of positive and negative prediction errors.

### BACKGROUND

Forecasting future events is useful in many industries. For example, manufacturers may want to forecast demand for the products they offer to ensure proper levels of raw materials and inventory at the appropriate point in time. Numerous forecasting techniques exist and some produce more accurate estimates than others in various situations. Knowing which forecasting technique to use may be problematic.

### BRIEF DESCRIPTION OF THE DRAWINGS

For a detailed description of various examples, reference will now be made to the accompanying drawings in which:

FIG. 1 shows a system in accordance with an implementation;

FIG. 2 provides a graph illustrating operation of an asymmetric mean absolute scaled error (AMASE) estimation process;

FIG. 3 shows an example of an implementation of an AMASE estimation system;

FIG. 4 illustrates an example of an AMASE estimation engine;

FIG. 5 shows a flow chart illustrating an example of a method; and

FIG. 6 shows a flow chart illustrating another example of a method.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

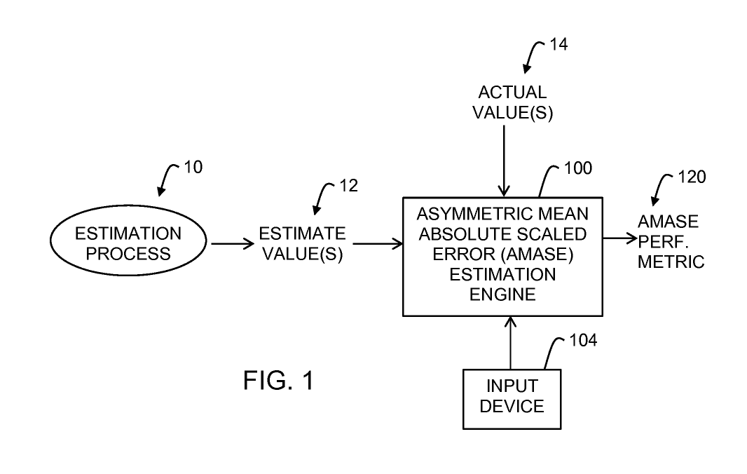

FIG. 1 illustrates that an estimation process 10 may provide one or more estimate values 12 to an asymmetric mean absolute scaled error (AMASE) estimation engine 100. The estimate values 12 may be an estimate of any event of interest. The term “event” may mean any future item that can be represented as a numerical value. Examples of events include future demand for a product, future revenue, future profit, and future cost.

The AMASE estimation engine 100 also receives one or more actual values 14. Each actual value 14 corresponds to an estimate value 12 in that each actual value 14 is the actual value of the event, which is known once the event actually occurs. For example, if the event is the demand for a company's product at a future date, the estimate value 12 is an estimate of the demand at that future date, while the actual value 14 is the actual demand for the product experienced by the company on designated date. The actual value 14 may be less than, equal to, or higher than the estimate value 12. How close to each other the estimate and actual values 12, 14 are depends on how well the estimation process 10 works. Some estimation processes 10 work better than others and how well one estimation process 10 works relative to other estimation processes may depend on the particular event being forecasted.

The AMASE estimation engine 100 computes an AMASE performance metric 120 based on the input estimate values 12 and actual values 14 as well as one or more parameters provided by a user via an input device 104. An implementation of the AMASE estimation engine 100 is described below. The AMASE engine 100 may be used to compute AMASE performance metrics 120 for estimate values 12 produced by different estimation processes 10 for a relative comparison of one estimation process to another.

The logic implemented by the AMASE estimation engine 100 may include the implementation of the following formula to compute an AMASE performance metric:

$${AMASE}_{θ , τ} = \frac{1}{n} {\sum }_{i = 1}^{n} \frac{{ρ}_{τ} ( {y}_{i} - {\hat{y}}_{i} )}{{θ}_{{y}_{i}} + ( 1 - θ ) {\hat{y}}_{i}} \qquad ( 1 )$$

where yᵢ represents the actual value of event i and ŷᵢ represents the estimate value for event i. The values ⊖ and (1−⊖) represent weights applied to the actual and estimate values, respectively, to control scaling. In various implementations, the AMASE estimation engine 100 computes a mean (e.g., algebraic mean, geometric mean) as in Eq. (1) or a median.

Further, the numerator of Eq. (1) above is a linear-linear loss function and is given by:

ρ_{τ}(μ)=μ(τ−I(μ<0)) (2)

where μ is the argument of the function and 0<τ<1. In Eq. (1), the argument μ of the loss function is yᵢ−ŷᵢ. The linear-linear loss function in Eq. (2) above evaluates to μ(τ−1) when the argument μ is less than a threshold (0 in this case); otherwise, the function evaluates to μτ when the argument μ is equal to or greater than the threshold (0). The value μ may be input by a user of the system. The values of ⊖ and τ also may be user-provided, but the value μ generically represents the prediction error (see Eq. 1 where μ is replaced by the error in prediction). Thus, the numerator of Eq. (1) evaluates to (yᵢ−ŷᵢ)(T−1) when (yᵢ−ŷᵢ)<0, and evaluates to (yᵢ−ŷᵢ) (T) when (yᵢ−ŷᵢ)≧0. In some implementations, the threshold of the applicable linear-linear loss function of Eq. (2) is a value other than 0. The value τ in the loss function of Eq. (1) above provides the user with control over the relative penalty on positive and negative prediction errors.

The AMASE performance metric computed using Eq. (1) is computed for all desired estimate values and corresponding actual values for one or more events. The events are indexed by the variable i and i may range from 1 to n.

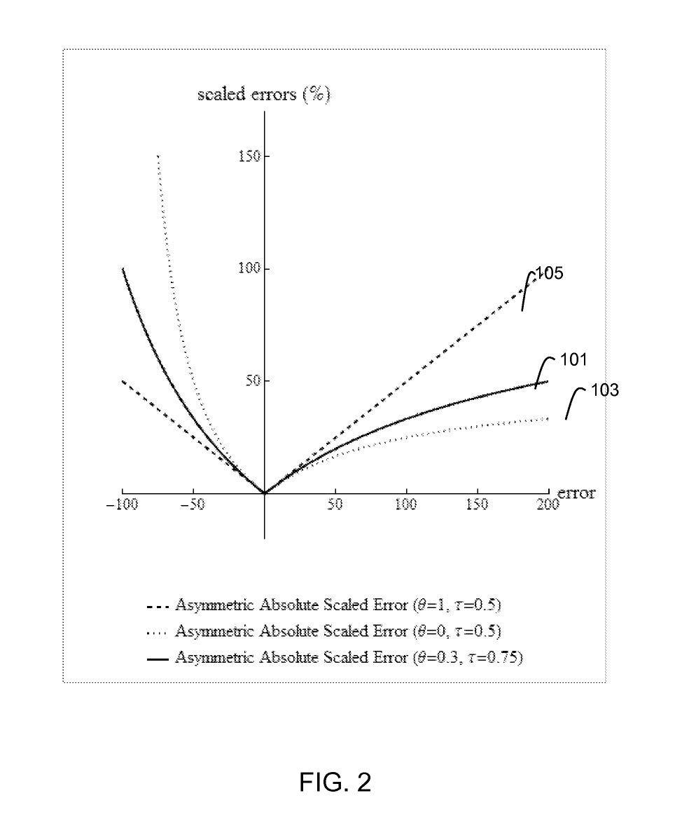

The AMASE performance metric of Eq. (1) permits a user to control the relation between a positive prediction error and a negative prediction error (i.e., a prediction error that over estimates versus a prediction error that under estimates). The τ parameter provides the user with some degree of control over prediction errors. The weights (⊖ and (1−⊖)) permit a user to control the relative contribution of actual and estimate value to the reference value. FIG. 2 illustrates the relationship between scaled error on the vertical axis as computed by via Eq. (1)

$$( \frac{{ρ}_{τ} ( {y}_{i} - {\hat{y}}_{i} )}{θ {y}_{i} + ( 1 - θ ) {\hat{y}}_{i}} )$$

and the absolute error (horizontal axis) as computed by 1−ŷ/y. The solid line 101 is for a ⊖ of 0.3 and a τ of 0.75, while the small dotted line 103 is for a ⊖ of 0 and a τ of 0.75. The larger dashed line is for a ⊖ of 1 and a τ of 0.5. The positive errors on the x-axis represent underestimates (estimate lower than actual value), while the negative errors represent overestimates (estimate larger than actual value). The dashed lines 105 are symmetrical about the y-axis meaning that the over and underestimates are weighted equally. However, the solid and small dotted lines 101 and 103 are not symmetrical about the y-axis which meaning that the over and underestimates are weighted differently. Whether the over and underestimates are weighted the same or different and, if different, how much more/less the overestimates are weighted than the underestimates is completely controllable by the user via the values of ⊖ and τ.

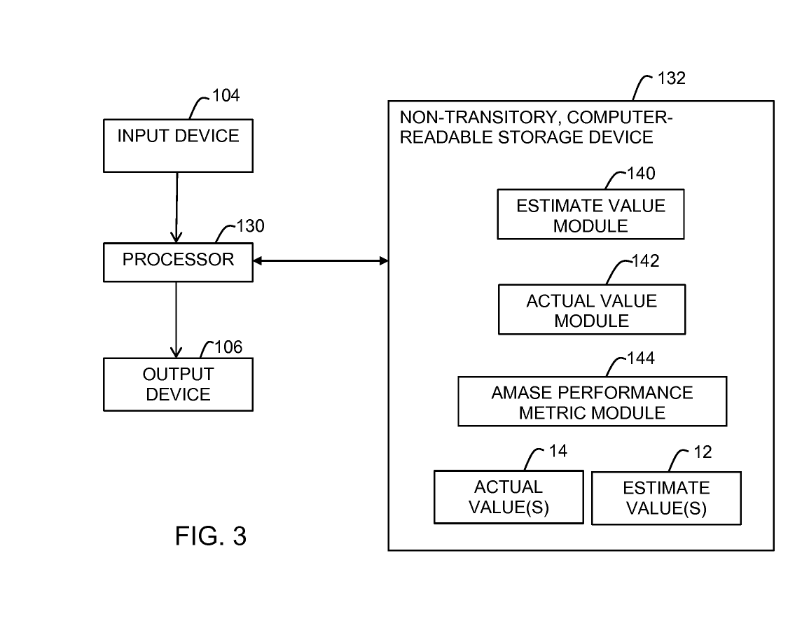

FIG. 3 illustrates an implementation of the AMASE estimation engine 100 of FIG. 1. As shown in FIG. 3, the AMASE estimation engine 100 includes a processor 130 (which may include multiple processors) coupled to the input device 104, an output device 106, and a non-transitory, computer-readable storage device 132. The input device 104 may include a keyboard, a mouse, a stylus, a touchpad, or other suitable type of user-input device. Using the input device 104, a user may specify or otherwise select the values of τ and ⊖ to control the behavior of the AMASE performance metric calculation in Eq. (1). The output device 106 may include a display or printer for providing feedback to the user such as the calculated performance metric itself.

The non-transitory, computer-readable storage device 132 may include volatile storage (e.g., random access memory), non-volatile storage (e.g., a hard disk drive, a Flash drive, an optical disc, etc.), or combinations of volatile and non-volatile storage. The storage device 132 includes various modules 140, 142, and 144 that contain instructions to be executed by the processor 130. Two or more of the executable modules may be separate or combined into a unified module. The non-transitory, computer-readable storage device 132 also may include the actual values 14 and the estimate values 12 to be input into the AMASE performance metric equation Eq. (1). All references herein to functions performed by modules 140, 142, and 144 include the processor 130 executing the relevant module.

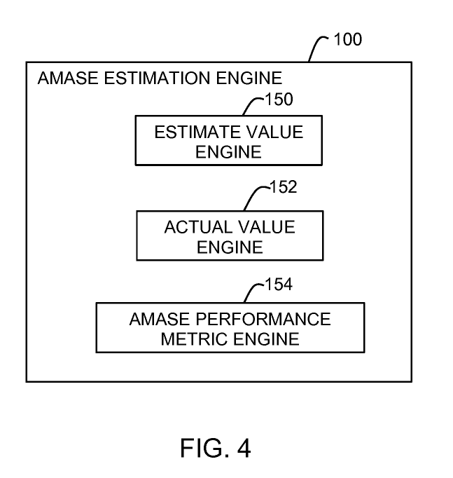

FIG. 4 shows an embodiment of the AMASE estimation engine 100 as comprising an estimate value engine 150, an actual value engine 152, and an AMASE performance metric engine 154. These engines 150-154 correspond to modules 140-144 of FIG. 4. Each engine 150-154 may be implemented as the processor 130 executing the corresponding module. Thus, the estimate value engine 150 may be implemented as processor 140 executing the estimate value module 140. All functionality attributed to a module 140-144 applies to the corresponding engine 150-154, and vice versa.

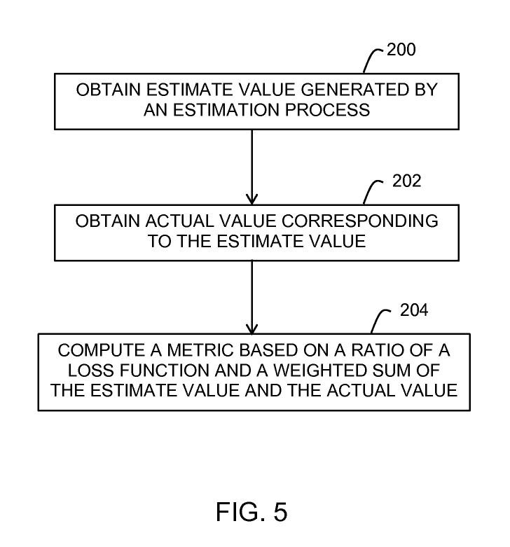

FIG. 5 illustrates a method related to the implementation of the AMASE performance metric of Eq. (1). The various operations depicted in FIG. 5 may be implemented by the AMASE estimation engine 100, and may be implemented by the various executable modules of FIG. 3. Referring to FIG. 5, in concert with FIG. 3, the method includes obtaining an estimate value generated by an estimation process (operation 200). Operation 200 may be performed by estimate value module 140. The estimate value module 140 may retrieve the estimate value 12 from, for example, the non-transitory, computer-readable storage device 132. The estimate value 12 may have been previously stored on the storage device 132 by an estimation process 10.

The method of FIG. 5 may also include obtaining (operation 202) an actual value 14 corresponding to the estimate value 12 obtained at operation 200. The actual value module 142 may retrieve the actual value 14, for example, from the non-transitory, computer-readable storage device 132. The actual value 14 may have been previously stored on the storage device 132 by processor 130 once the actual value was generated, derived, or otherwise created. For example, if the event in question is the future demand for a product or service on a certain date, once the demand is actually known (e.g., receipt has occurred of purchase orders, requests, etc.), the actual value for that event can be stored on the storage device 132.

Referring still to FIG. 5, the method includes an operation 204 in which a performance metric is computed based on a ratio of a loss function (e.g., the loss function of Eq. (2)) and a weighted sum of the estimate value and the actual value obtained from operations 200 and 202. This operation may be performed by the AMASE performance module 144. The loss function includes a user-specified penalty parameter (τ) that permits the user to control a relative penalty of positive and negative prediction errors. The ratio may correspond to the ratio of the numerator and denominator of Eq. (1).

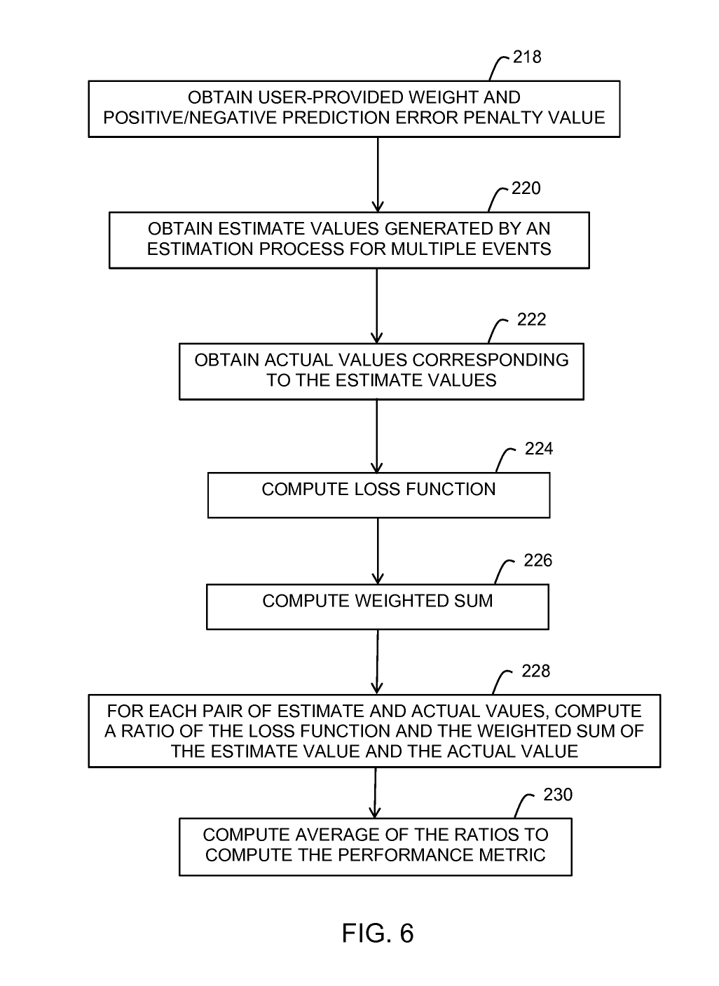

In some examples, multiple events are being estimated, such as demand for a product at different times, demand for different products, etc. FIG. 6 illustrates a method which is similar to that of FIG. 5 but is for computing a performance metric based on multiple estimate values and corresponding actual values.

At 218, the method includes obtaining a user-provided weight (e.g., ⊖) and a positive/negative prediction error penalty value (e.g., τ). Such values may be provided by a user via the input device 104 or may be retrieved by the processor 130 from the storage device 132. At 220, the method includes obtaining estimate values generated by an estimation process for multiple events and at 222, the method includes obtaining corresponding actual values.

At 224, the method includes computing a loss function based on an argument for each estimated event. The argument may include the difference between actual and estimate values (e.g., yᵢ−ŷᵢ.) for each such event. The loss function may be the function of Eq. (2) which includes the value of τ which may be obtained from the user at 218. The method further includes (at 226) computing a weighted sum of the estimate value and the corresponding actual value for each such event. The weights include the user-provided weight from operation 218 which may include the value of ⊖ (and the computed value of 1−⊖.

At 228 and for each pair of corresponding estimate and actual values, the method includes computing a ratio of the computed loss function and the weighted sum of the estimate value and the corresponding actual value. At 230, the method includes computing an mean (e.g., algebraic mean, geometric mean) or median of all such ratios to compute the metric.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
obtaining, by an estimate value engine, an estimate value generated by an estimation process;
obtaining, by an actual value engine, an actual value corresponding to the estimate value; and
computing, by an asymmetric mean absolute scaled error (AMASE) performance metric engine, a metric based on a ratio of a loss function and a weighted sum of the estimate value and the actual value, the loss function including a penalty parameter to control a relative penalty of positive and negative prediction errors.

2. The method of claim 1 wherein the loss function includes an argument, and the loss function evaluates to a product of the argument and a penalty value when the argument is greater than or equal to a threshold.

3. The method of claim 2 wherein the argument is a difference between the actual value and the estimate value.

4. The method of claim 2 wherein the loss function evaluates to a product of the argument and a quantity of the penalty minus one when the argument is less than the threshold.

5. The method of claim 4 wherein the threshold is zero.

6. The method of claim 1 further comprising computing multiple ratios of the loss function and the weighted sum, each ratio being for a pair of estimate and actual values for a different event.

7. The method of claim 6 wherein computing the metric comprises computing a mean or median of the multiple ratios.

8. A non-transitory, computer-readable storage device including instructions that are executable by a processor and, when executed, cause the compute to:
obtain an estimate value generated by an estimation process;
obtain an actual value corresponding to the estimate value; and
compute a ratio of a loss function and a weighted sum of the estimate value and the actual value, the loss function including a user-specified penalty parameter that permits the user to control a relative penalty of positive and negative prediction errors.

9. The non-transitory, computer-readable storage device of claim 8 wherein the instructions further cause the processor to compute multiple ratios of the loss function and the weighted sum, each ratio being for a different pair of estimate and actual values.

10. The non-transitory, computer-readable storage device of claim 9 wherein the instructions cause the processor to compute the metric by computing a mean or median of the ratios.

11. The non-transitory, computer-readable storage device of claim 8 wherein the loss function includes an argument, and the loss function evaluates to a product of the argument and a penalty value when the argument is greater than or equal to a threshold.

12. The non-transitory, computer-readable storage device of claim 11 wherein the loss function evaluates to a product of the argument and a quantity of the penalty minus one when the argument is less than the threshold.

13. The non-transitory, computer-readable storage device of claim 11 wherein the argument is a difference between the actual value and the estimate value.

14. The non-transitory, computer-readable storage device of claim 12 wherein the threshold is zero.

15. A system, comprising:
an asymmetric mean absolute scaled error (AMASE) estimation engine to receive a first parameter as well as an estimate value for an event and a corresponding actual value for the events, and to compute a performance metric by computing a ratio of a loss function and a weighted sum of a pair of corresponding estimate and actual values;
wherein the loss function includes the first parameter that permits control of a relative penalty of positive and negative prediction errors.

16. The system of claim 15 wherein the AMASE estimation engine is to compute multiple ratios of the loss function and the weighted sum, each ratio being for a different pair of estimate and actual values.

17. The system of claim 16 wherein the AMASE estimation engine is to compute the performance metric by computing a mean or median of the ratios.

18. The system of claim 15 wherein the loss function includes an argument, and the loss function evaluates to a product of the argument and a penalty value when the argument is greater than or equal to a threshold.

19. The system of claim 18 wherein the loss function evaluates to a product of the argument and a quantity of the penalty minus one when the argument is less than the threshold.

20. The system of claim 18 wherein the argument is a difference between the actual value and the estimate value.
